(19) United States
(12) Patent Application Publication
(10) Pub. No.: US 2024/0205825 A1
(43) Pub. Date: Jun. 20, 2024

(54) CROSS-LINK POWER MANAGEMENT IN MULTI-LINK OPERATION

(71) Applicant: Samsung Electronics Co., Ltd., Suwon-si (KR)

(72) Inventors: Vishnu Vardhan Ratnam, Plano, TX (US); Rubayet Shafin, Allen, TX (US); Boon Loong Ng, Plano, TX (US); Peshal Nayak, Plano, TX (US); Yue Qi, Plano, TX (US); Elliot Jen, Taipei City (TW)

(21) Appl. No.: 18/484,377

(22) Filed: Oct. 10, 2023

Related U.S. Application Data
(60) Provisional application No. 63/433,329, filed on Dec. 16, 2022.

(51) Int. Cl. H04W 52/02

(52) U.S. Cl. CPC H04W 52/0229

(57) ABSTRACT

A wireless communication network includes an access point (AP) multi-link device (MLD) and a non-AP MLD. A STA of a non-AP MLD may inform the AP MLD about changes in power management mode and/or power save state for another STA affiliated with the same non-AP MLD via cross-link signaling. The AP MLD may inform the non-AP MLD about its capability to receive, and the time required to process cross-link signaling for the changes in power management mode and/or power save state.

### CROSS-REFERENCE TO RELATED APPLICATIONS

This application claims the benefit of priority from U.S. Provisional Application No. 63/433,329, entitled “METHOD AND APPARATUS FOR CROSS-LINK POWER MANAGEMENT AND POWER SAVE STATE INDICATION IN MLO,” filed Dec. 16, 2022, which is incorporated herein by reference in its entirety.

### TECHNICAL FIELD

This disclosure relates generally to a wireless communication system, and more particularly to, for example, but not limited to, multi-link operation in a wireless communication system.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One embodiment of the present disclosure may provide a non-access point (AP) multi-link device (MLD) associated with an AP MLD in a wireless network. The non-AP MLD may comprise at least two stations (STAs) and a processor coupled to the at least two STAs. The processor is configured to determine power management mode change or power save state change for one or more STAs affiliated with the non-AP MLD. The processor is configured to transmit, to a first AP affiliated with the AP MLD on a first link established between a first STA affiliated with the non-AP MLD and the first AP, a frame including a field that indicates the power management mode change or the power save state change for the one or more STAs affiliated with the non-AP MLD.

In some embodiments, the field includes a first subfield that indicates if the field includes power management mode change indication or power save state change indication.

In some embodiments, the field includes a second subfield that indicates one or more links of the AP MLD that are associated with the power management mode change or the power save state change.

In some embodiments, the power management mode change is a change from active mode to power save mode or a change from power save mode to active mode, and the power save state change is a change from doze state to awake state or a change from awake state to doze state.

In some embodiments, the frame includes a third subfield that indicates if the power management mode transitions from active mode to power save mode or from power save mode to active mode.

In some embodiments, the power management mode change is determined based on the first subfield and the third subfield.

In some embodiments, the processor is further configured to participate in frame exchange with at least one AP affiliated with the AP MLD on each respective link between the non-AP MLD and the AP MLD, in a case that the field indicates that the one or more STAs transition to active mode or awake state, and wherein the at least one AP is associated with at least one of the one or more STAs.

In some embodiments, the processor is further configured to receive capability information from the AP MLD that indicates whether the AP MLD supports receiving power management mode change indication or power save state change indication for one or more STAs affiliated with the non-AP MLD.

In some embodiments, the processor is further configured to receive processing delay information that indicates an amount of time to process power management mode change indication or power save state change indication.

In some embodiments, the processor is configured to change the power management mode or the power save state for the one or more STAs at a time determined based on the amount of time indicated by the processing delay information.

One embodiment of present disclosure may provide an access point (AP) multi-link device (MLD) associated with a non-AP MLD in a wireless network. The AP MLD may comprise at least two APs and a processor coupled to the at least two APs. The processor configured to receive, from a first STA affiliated with the non-AP MLD on a first link established between the first STA and a first AP affiliated with the AP MLD, a frame including a field that indicates power management mode change or power save state change for one or more STAs affiliated with the non-AP MLD. The processor is configured to initiate frame exchange with at least one of the one or more STAs on each respective link between the AP MLD and the non-AP MLD in response to determining that the one or more STAs transition to active mode or awake state based on the field included in the frame. The processor is configured to initiate buffering of bufferable units to at least one of the one or more STAs in response to determining that the one or more STAs transition to doze state based on the field included in the frame.

In some embodiments, the field includes a first subfield that indicates if the field includes power management mode change indication or power save state change indication.

In some embodiments, the field includes a second subfield that indicates one or more links of the AP MLD that are associated with the power management mode change or the power save state change.

In some embodiments, the power management mode change is a change from active mode to power save mode or a change from power save mode to active mode and the power save state change is a change from doze state to awake state or a change from awake state to doze state.

In some embodiments, the frame includes a third subfield that indicates if the power management mode transitions from active mode to power save mode or from power save mode to active mode.

In some embodiments, the processor is configured to determine the power management mode change based on the first subfield and the third subfield.

In some embodiments, the processor is further configured to transmit capability information to the non-AP MLD that indicates whether the AP MLD supports receiving power management mode change indication or power save state change indication for one or more STAs affiliated with the non-AP MLD.

In some embodiments, the processor is further configured to transmit processing delay information that indicates an amount of time to process power management mode change indication or power save state change indication.

In some embodiments, the processor is configured to initiate the frame exchange with the at least one of the one or more STAs or to initiate buffering of the bufferable units to at least one of the one or more STAs at a time determined based on the processing delay information.

### BRIEF DESCRIPTION OF THE DRAWINGS

FIG. 1 shows an example of a wireless network in accordance with an embodiment.

FIG. 2A shows an example of an AP in accordance with an embodiment.

FIG. 2B shows an example of a STA in accordance with an embodiment.

FIG. 3 shows an example of multi-link operation in accordance with an embodiment.

FIG. 4 shows an example of a TID-to-Link Mapping element in accordance with an embodiment.

FIGS. 5A and 5B show examples of multi-link operation in accordance with an embodiment.

FIGS. 6A and 6B show examples of multi-link operation in accordance with an embodiment.

FIG. 7 shows an example of a MLD Capabilities and Operations field in a Basic Multi-link element in accordance with an embodiment.

FIG. 8A shows an example table of control ID subfield values for HE-variant HT control field in accordance with an embodiment.

FIG. 8B shows an example of control information subfield format in the LI Control subfield in accordance with an embodiment.

FIG. 8C shows an example of the subtype subfield of the LI Control subfield in accordance with an embodiment.

FIG. 8D shows another example of control information subfield format in the LI Control subfield in accordance with an embodiment.

FIG. 9A shows an example of a MLPM Notification frame format in accordance with an embodiment.

FIG. 9B shows an example of Protected EHT Action field values in accordance with an embodiment.

FIG. 9C shows an example of a MLPM Notification field format in accordance with an embodiment.

FIG. 10 shows a flow chart illustrating an example process for an AP MLD in accordance with an embodiment.

FIG. 11 shows a flow chart illustrating an example process for a non-AP MLD in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

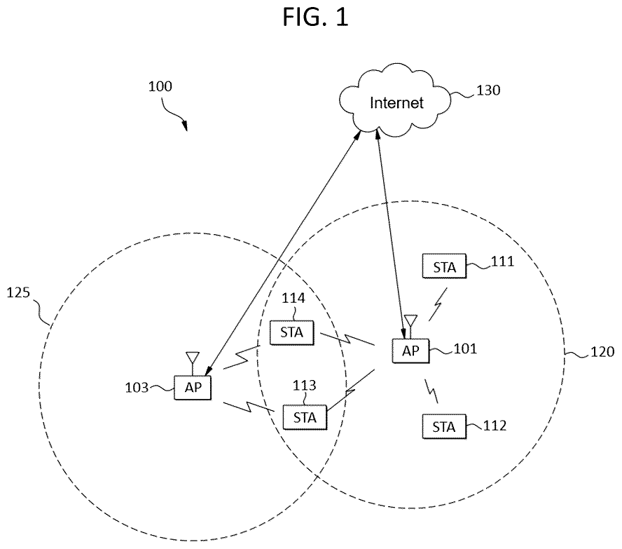

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

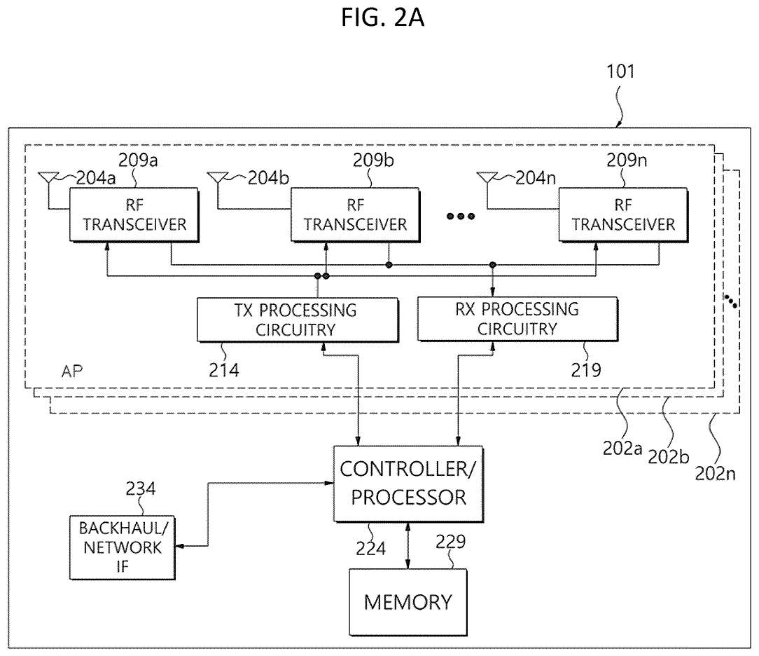

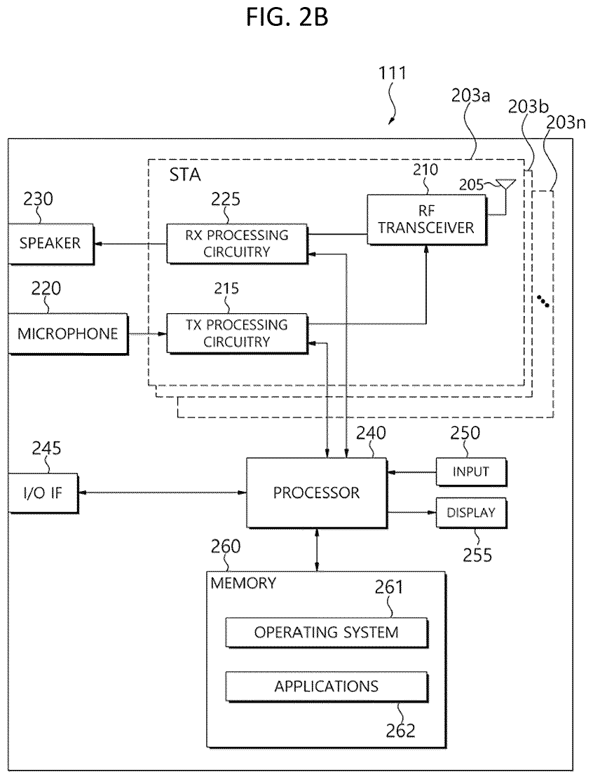

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

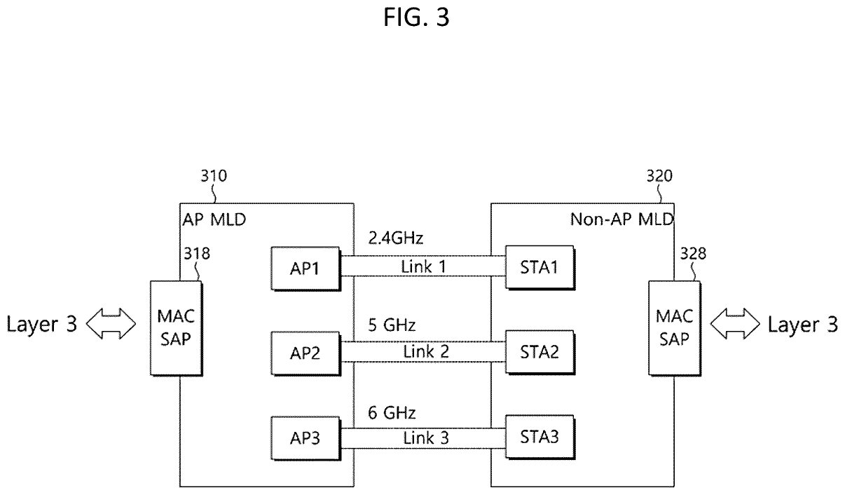

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

In order to prioritize transmission of different types of traffic, which are identified by a traffic identifier (TID), across the setup links, the non-AP MLD 320 may negotiate a TID-to-link mapping with the AP MLD 310. The TID-to-link mapping allows the AP MLD 310 and the non-AP MLD 320 to determine how frames belonging to TIDs are assigned for transmission on each setup link in the uplink and downlink directions, respectively. When at least one TID associated with a non-AP MLD 320 is mapped to a setup link in either uplink or downlink direction, the link is referred to as an enabled link for the non-AP MLD 320. By default, all TIDs are mapped to all the setup links between the AP MLD 310 and the non-AP MLD 320, and this mapping is referred to as a default TID-to-link mapping. During association, the non-AP MLD 320 can use a negotiation procedure to negotiate a non-default mapping of TIDs to the setup links, by including a TID-to-Link Mapping element in an association request frame or a reassociation request frame. The non-default mapping can be either where all TIDs are mapped to the same subset of setup links, or where not all TIDs are mapped to the same subset of setup links. The AP MLD 310 can also use a broadcast procedure to indicate switching to a non-default mapping for all associated non-AP MLDs. In default mapping mode, all TIDs are mapped to all setup links for downlink and uplink and all setup links are enabled. The non-AP MLD 320 operates under default mapping mode when a TID-to-link mapping negotiation did not occur or was unsuccessful.

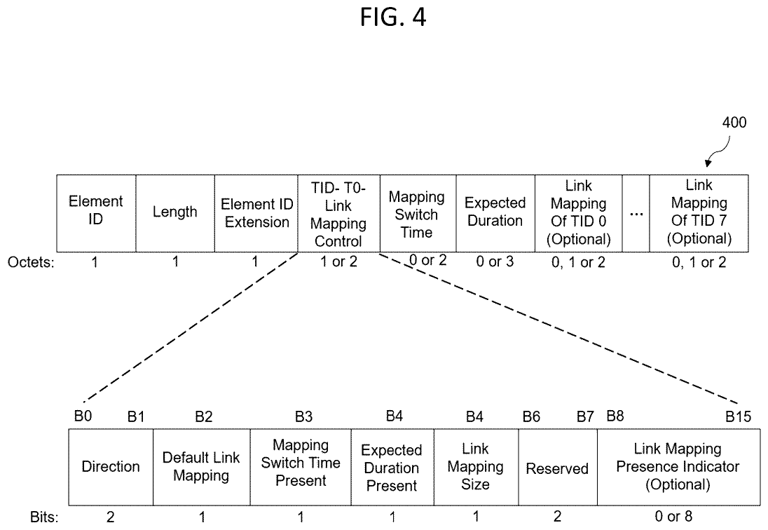

FIG. 4 shows an example of a TID-to-Link Mapping element 400 in accordance with an embodiment. This example of FIG. 4 can be applicable to IEEE 802.11be standard and any of future amendments to IEEE 802.11 standard. The TID-to-Link Mapping element 400 may indicate the links on which frames belongings to each TID can be exchanged.

As shown in FIG. 4, the TID-to-Link Mapping element 400 may include an Element ID field, a Length field, an Element ID Extension field, a TID-to-Link Mapping Control field, a Mapping Switch Time field, an Expected Duration field, and optional Link Mapping of TID n fields.

The Element ID field and the Element ID Extension field may include information to identify the TID-to-Link Mapping element 400. The Length field may indicate a length of the TID-to-Link Mapping element 400.

The TID-to-Link Mapping Control field may include a Direction subfield, a Default Link Mapping subfield, a Mapping Switch Time Present subfield, an Expected Duration Present subfield, a Link Mapping Size subfield, a Reserved subfield, and an optional Link Mapping Presence Indicator subfield. The Direction subfield may indicate if the TID-to-Link Mapping element 400 is for downlink frames, uplink frames, or both. For example, the Direction subfield may be set to 0 for downlink frames, 1 for uplink frames, and 2 for frames transmitted both on downlink and uplink. The Default Link Mapping subfield may indicate if the TID-to-Link Mapping element 400 represents default TID-to-link mapping. For example, the subfield may be set to 1 for default mapping and 0 for non-default mapping. The Mapping Switch Time Present subfield may indicate if the Mapping Switch Time field is present in the TID-To-Link Mapping element 400. The Expected Duration Present subfield may indicate if the Expected Duration field is present in the TID-To-Link Mapping element 400. The Link Mapping Size subfield may indicate the length of the Link Mapping of TID n field. The Link Mapping Presence Indicator subfield may indicate whether the Link Mapping of TID n fields are present in the TID-To-Link Mapping element 400.

The Mapping Switch Time field is present when the TID-to-Link Mapping element 400 is transmitted by an AP affiliated with an AP MLD in a beacon or probe response frame and the indicated TID-to-link mapping is not yet established.

The Expected Duration field may indicate the duration for which the proposed TID-to-link mapping is expected to be effective when the Mapping Switch Time field is present, and the remaining duration for which the proposed TID-to-link mapping is expected to be effective when the Mapping Switch Time field is not present.

The Link Mapping of TID n field (where n=0, 1, . . . , 7, for example) may indicate the links on which frames belonging to the TID n are allowed to be sent. The Link Mapping of TID n fields may carry a bitmap of the links to which the TID n is mapped. When the Default Link Mapping subfield of the TID-To-Link Mapping Control field represents default TID-to-link mapping, the Link Mapping of TID n fields may not be present. For example, when the Direction subfield is set to 0, the Default Link Mapping subfield is set to 0, and the Link Mapping of TID 0 field is configured to 10000 . . . 0, this configuration indicates that downlink data corresponding TID 0 is transmitted on Link 1.

The TID-to-Link Mapping element 400 may be included in various management frames, for example, a beacon frame, an association request/response frame, a re-association request/response frame, or a probe response frame.

In order to allow non-AP devices to save power, there may be several power management solutions. For example, a STA of the non-AP MLD may be able to operate and switch into two possible states: awake state and doze state. In the awake state, the STA of the non-AP MLD may continuously monitor the channel and transmit and receive frames to/from an AP device or a non-AP device. However, in the doze state, the STA of the non-AP MLD may be unable to transmit or receive frames. Various power save mechanisms have been defined in IEEE 802.11 standard, such as normal power save (PS) mode, automatic power save delivery (APSD), wireless network management (WNM) power save mode, power save multi-poll mode, spatial multiplexing PS, independent basic service set (IBSS) power save, and very high throughput (VHT) transmission opportunity (TXOP) power save. In those power save mechanisms, a STA may transmit a physical layer (PHY) protocol data unit (PPDU) with a power management (PM) bit in the frame control field set to 1 in order to indicate to the AP MLD that the STA is transitioning from active mode to power save mode. Similarly, the STA may transmit a PPDU with the PM bit set to 0 when the STA intends to transition from power save mode to active mode. In some implementations, a non-AP STA may be one of two power management modes: active mode and power save mode. In the active mode, the STA may receive and transmit frames at any time, remaining in the awake state. In the power save mode, the STA may enter the awake state to receive or transmit frames but otherwise remains in the doze state. When a STA is in the doze state, it may be unable to sense the channel and, therefore, may not be aware of the current state of the channel or the end of existing transmissions. This condition may be referred to as loss of medium synchronization. Consequently, when the STA transmits a frame immediately in this condition, which is considered to have lost medium synchronization, it may cause a collision with existing transmissions. Accordingly, the STA, which is transitioning from doze state to awake state to transmit a frame, shall perform clear channel assessment (CCA) procedure until a frame is detected by which it can set its network allocation vector (NAV) timer, or until a period of time indicated by the NAVSyncDelay has transpired. Only then may the STA transmit the frame.

When a STA is in the doze state, the associated AP of the AP MLD buffers “buffer-able packets” that are addressed to the STA but unable to be delivered to another STA associated with the same non-AP MLD that is in awake state or in active mode. Such buffered packets may be referred to as buffered traffic or buffered bufferable units (BUs) and are delivered to the STA when the STA returns to awake state.

In order to indicate to all the associated non-AP devices about their pending BUs via a broadcast or multi-cast signaling, each AP affiliated with the AP MLD periodically includes a traffic information map (TIM) element in beacon frames. Optionally, a multi-link traffic indication element may be included within the beacon frames that the AP transmits. Alternatively, each AP of the AP MLD may transmit these elements as a separate periodic broadcast TIM frame. Thus, the non-AP device can become aware of pending traffic buffered at the AP by listening to the TIM element and/or multi-link traffic indication element in the beacon frames.

A STA affiliated with a non-AP device may transmit a frame, such as a power save (PS)-Poll frame and U-APSD trigger frame, to indicate to an AP that it is in awake state and ready to receive frames. The indication may not be required for the STA to transmit frames in the uplink direction. When an AP affiliated with an AP MLD receives a PS-Poll frame or U-APSD trigger frame from a STA affiliated with an associated non-AP MLD that is in power save mode, the AP can transmit buffered BUs to the STA if buffered BUs are available and have not been discarded for implementation dependent reasons. Otherwise, the AP may transmit a QoS Null frame.

After initiating a frame exchange sequence with a STA of a non-AP MLD that is in power save mode to transmit BUs, the AP may utilize the More Data subfield in the frame control field of a transmitted frame in order to inform the non-AP MLD whether more individually addressed BUs are buffered for the non-AP MLD. These buffered BUs correspond to Data frames with traffic identifiers (TIDs) that are mapped to the corresponding link or Management frames that are not a transmit power control (TPC) request frame or Link Measurement Request frame. When there are no pending buffered BUs, the More Data subfield may be set to 0 and the STA may return to doze state after completing the frame exchange sequence.

When a STA affiliated with a non-AP MLD transitions from doze state to awake state, it may not be able to transmit a PS-Poll frame or U-APSD trigger frame immediately after waking up due to the loss of medium synchronization, as explained above. Furthermore, because the power save operation is performed on a per-link basis, each STA transitioning from doze state to awake state has to independently transmit a respective PS-Poll frame or U-APSD trigger frame to indicate it has transitioned to the awake state. This may lead to heightened complexity and increased overhead. Furthermore, these constraints may also apply to the power management mode switch indication, which is similarly performed on a per-link basis in multi-link operation.

This disclosure provides methods by which a STA of a non-AP MLD can inform the AP MLD of changes in power save state or power management mode of another STA affiliated with the same non-AP MLD. This disclosure also provides methods for an AP MLD to indicate the time required for inter-AP information exchange. It may be a period of time after which the indicated cross-link power management mode change or cross-link power save state change will take effect.

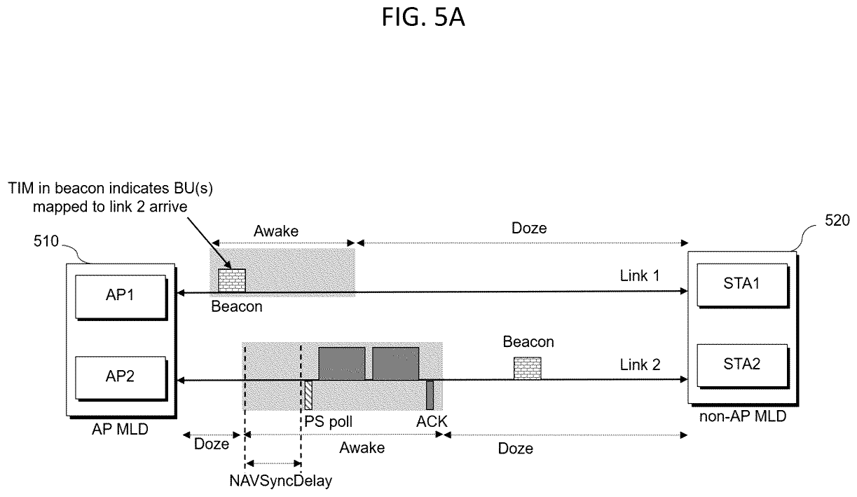

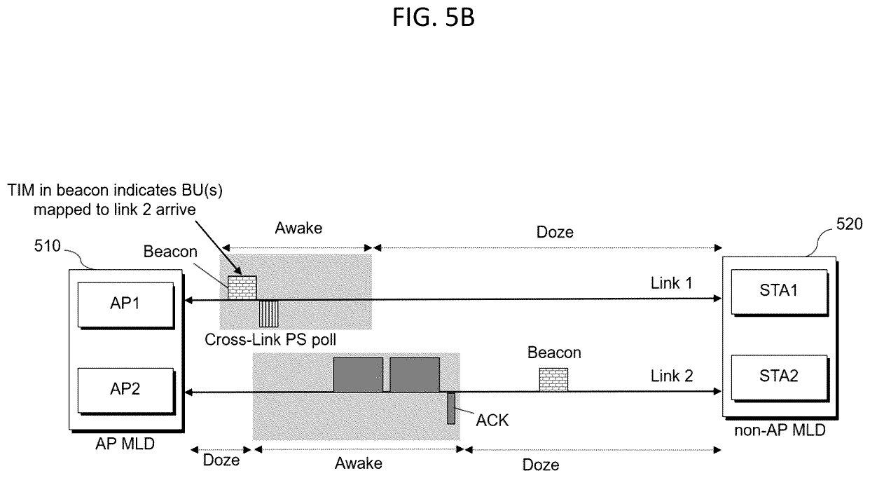

FIGS. 5A and 5B show examples of multi-link operation in accordance with an embodiment. In FIGS. 5A and 5B, AP MLD 510 may include two affiliated APs (e.g., AP 1 and AP 2) and non-AP MLD 520 may include two affiliated STAs (e.g., STAT 1 and STA 2). AP MLD 510 and non-AP MLD 520 may be examples of AP MLD 310 and non-AP MLD 320 illustrated in FIG. 3, respectively. AP1 and STA 1 may establish Link 1, and AP 2 and STA 2 may establish Link 2. Each link may enable channel access and perform frame exchanges between AP MLD 510 and non-AP MLD 520 independently. In this example, it is assumed that non-AP MLD 520 is in power save mode on both Link 1 and Link 2.

Referring to FIG. 5A, while operating in power save mode, STA 1 may wake up to receive a beacon frame transmitted from AP 1. The beacon frame may include a TIM element that indicates that there are BUs mapping to Link 2 at AP MLD 510. Thus, non-AP MLD 520 determines that AP MLD 510 has BUs for STA 2. Based on this determination, STA 2 that is in doze state may wake up and send a PS-Poll frame to AP 2 after a period of time indicated by NAVSyncDelay. The NAVSyncDelay is a delay time to be used prior to transmitting when transitioning from doze state to awake state. The PS-Poll frame indicates to AP 2 that it has transitioned to the awake state. Then, STA 2 participates in frame exchanges with AP 2 to fetch buffered BUs via Link 2. After successful frame exchanges, STA 2 may transition to the doze state. In this example, STA 2 that has transitioned from doze state to awake state may not be able to transmit the PS-Poll frame immediately upon waking up because of the delay caused by the NAVSyncDelay. This may result in some latency in retrieving the buffered BUs by STA 2 on Link 2.

Referring to FIG. 5B, while operating in power save mode, STA 1 may wake up to receive a beacon frame transmitted from AP 1. The beacon frame may include a TIM element that indicates that there are BUs mapped to Link 2 at AP MLD 510. Thus, non-AP MLD 520 determines that AP MLD 510 has buffered BUs for STA 2. Based on this determination, STA 2 wakes up and transitions to the awake state. In the meantime, STA 1 on behalf of STA 2 may transmit a cross-link PS-Poll frame indicating that STA 2 is in awake state and AP 2 can deliver buffered BUs to STA 2 immediately via Link 2. Subsequently, STA 2 immediately participates in frame exchanges with AP 2 to fetch buffered BUs via Link 2. After successful frame exchanges, STA 2 may transition to the doze state. In this example, there is no delay caused by the NAVSyncDelay, as shown in FIG. 5A, because STA 1 has already entered the awake state to listen to the beacon frame and immediately transmit the cross-link PS-Poll frame on behalf of STA 2.

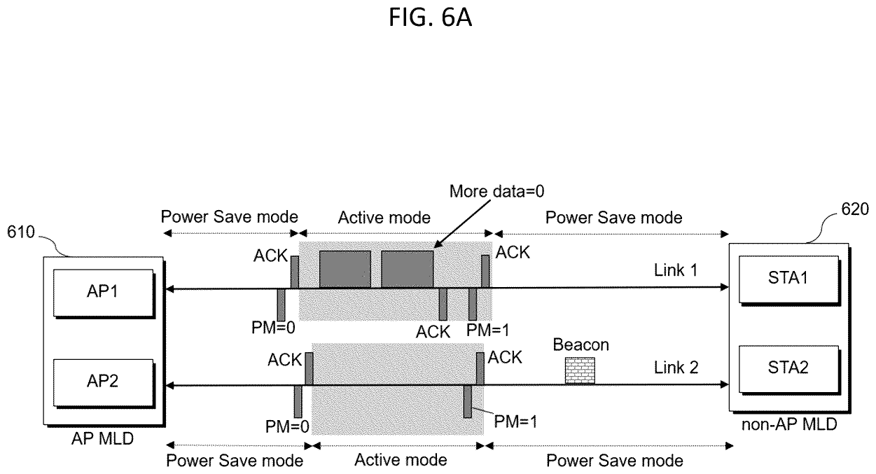

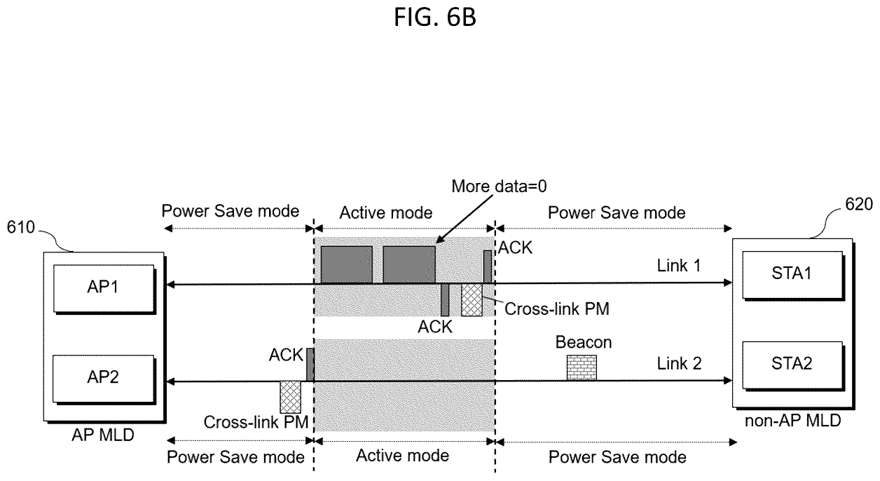

FIGS. 6A and 6B show examples of multi-link operation in accordance with an embodiment. In FIGS. 6A and 6B, AP MLD 610 may include two affiliated APs (e.g., AP 1 and AP 2) and non-AP MLD 620 may include two affiliated STAs (e.g., STAT 1 and STA 2). AP MLD 610 and non-AP MLD 620 may be examples of AP MLD 310 and non-AP MLD 320 illustrated in FIG. 3, respectively. AP1 and STA 1 may establish Link 1 and AP 2 and STA 2 may establish Link 2. Each link may enable channel access and perform frame exchanges between AP MLD 610 and non-AP MLD 620 independently. In this example, it is assumed that non-AP MLD 520 is in power save mode on both Link 1 and Link 2. Each STA of non-AP MLD 620 may transition between power save mode and active mode independently. For instance, a STA of non-AP MLD 620 may transition from active mode to power save mode immediately after successfully frame exchanges. Additionally, the STA of the non-AP MLD 620 may transition back to the active mode to transmit frames at a later time.

Referring to FIG. 6A, during the initial portion of the illustration, both STA 1 and STA 2 of the non-AP MLD 620 are in power save mode. At some point, both STA 1 and STA 2 of non-AP MLD 620 may want to transition to active mode, and each STA of the non-AP MLD 620 performs a respective procedure for power management mode transition. More specifically, each STA of the non-AP MLD 620 may independently indicate to its respective AP (i.e., AP 1 or AP 2) that it is entering active mode by setting PM bit to 0 in the frame control field of a transmitted PPDU. Subsequently, each STA of the non-AP MLD 620 may engage in frame exchanges with its corresponding AP of the AP MLD 610. After a certain period, each STA may re-enter power save mode by setting the PM bit to 1 following successful frame exchanges. In this example, each STA of the non-AP MLD 620 has to independently send a frame to its respective AP to indicate a change in power management mode. This process may result in unnecessary overhead for both non-AP MLD 620 and AP MLD 610. FIG. 6B provides one example solution to the aforementioned issue.

Referring to FIG. 6B, during the initial portion of the illustration, both STA 1 and STA 2 of the non-AP MLD 620 are in power save mode. At some point, both STA 1 and STA 2 of non-AP MLD 620 may want to transition to active mode. Unlikely the example of FIG. 6A, STA 2 of the non-AP MLD 620 may transmit a cross-link power management (PM) indication to AP 2 of the AP MLD 610 via Link 2. The cross-link PM indication may indicate to AP 2 that both STA 1 and STA 2 of the non-AP MLD 620 are transitioning from power save mode to active mode. In response to the cross-link PM indication, AP MLD 610 may transmit traffic on either link. In this example, AP 1 of the AP MLD 610 may initiate frame exchanges with STA 1 of the non-AP MLD 620 via Link 1. After successful frame exchanges, STA 1 of the AP MLD 610 may transmit a cross-link PM indication to AP 1 of the AP MLD 610 via Link 1. This cross-link PM indication may indicate to AP 1 that both STA 1 and STA 2 of the non-AP MLD 620 are transitioning back to power save mode from active mode. Subsequently, both STA 1 and STA 2 re-enter power save mode.

An AP MLD may be capable of receiving a PM mode switch indication for a first STA affiliated with an associated non-AP MLD via a frame transmitted by a second STA affiliated with the same non-AP MLD. The indication may be referred to as ‘cross-link PM mode switch (or change) indication’ or ‘cross-link PM mode indication’ in this disclosure. Similarly, an AP MLD may be capable of receiving a power save state switch indication for a first STA affiliated with an associated non-AP MLD via a frame transmitted by a second STA affiliated with the same non-AP MLD. The indication may be referred to as ‘cross-link power save state switch (or change) indication’ or ‘cross-link power save state indication.’

The AP MLD may indicate these capabilities to receive cross-link PM mode switch indication and/or cross-link power save state switch indication by introducing one or more new subfields or bits in the MLD Capabilities and Operation field in the Basic Multi-link element. For example, there may be a new subfield called a Multi-link Power Management (MLPM) Support subfield in the MLD Capabilities and Operations field, which jointly indicates support for receiving the cross-link PM mode switch indication and the cross-link power save state switch indication.

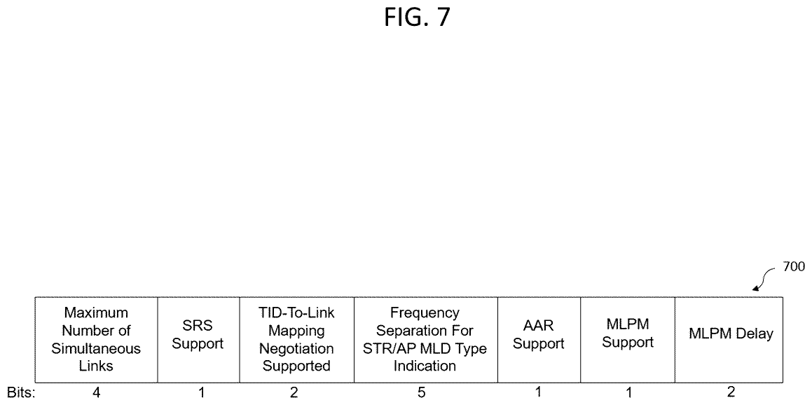

FIG. 7 shows an example of a MLD Capabilities and Operations field in a Basic Multi-link element transmitted by an AP affiliated with an AP MLD in accordance with an embodiment.

In FIG. 7, the MLD Capabilities and Operations field 700 may include a Maximum Number of Simultaneous Links subfield, an SRS (single response scheduling) Support subfield, a TID-To-Link Mapping Negotiation Supported subfield, a Frequency Separation For STR (simultaneous transmit and receive)/AP MLD Type Indication subfield, an AAR (AP assistance request) Support subfield, a MLPM Support subfield, and a MLPM Delay subfield.

The Maximum Number of Simultaneous Links subfield may indicate the maximum number of STAs affiliated with the MLD that supports simultaneous transmission or reception of frames on the respective links. The SRS Support subfield may indicate support for the reception of a frame that carries an SRS Control subfield. The TID-To-Link Mapping Negotiation Support subfield may indicate that support for TID-to-link mapping (TTLM) negotiation. The Frequency Separation For STR/AP MLD Type Indication subfield may include the Frequency Separation For STR indication and the AP MLD Type Indication. The Frequency Separation For STR indication may indicate the minimum frequency gap between any two links that is recommended by the non-AP MLD for STR operation. The frequency gap is specified as the difference between the nearest frequency edges of the two links. The AP MLD Type Indication may indicate the type of an AP MLD. In particular, it may indicate if the AP MLD is a non-simultaneous transmit and receive (NSTR) mobile AP MLD. The AAR Support subfield may indicate support for receiving a frame with an AAR Control subfield.

The MLPM Support subfield may indicate support for receiving cross-link PM mode switch indication and cross-link power save state switch indication. More specifically, when the AP MLD can receive cross-link PM mode switch indication and cross-link power save state switch indication, the MLPM Support subfield may be set to 1. Otherwise, it may be set to 0. In some implementations, the MLPM Support subfield may indicate support for receiving cross-link PM mode switch indication and/or cross-link power save state switch indication. In some implementations, all APs affiliated with the same AP MLD may indicate the same capabilities associated with MLPM Support subfield.

The MLPM Delay may indicate the amount of time that the AP MLD needs to process and successfully apply the cross-link PM mode switch indication and/or cross-link power save state switch indication. The MLPM Delay is an inter-AP processing delay to process and successfully apply the cross-link PM mode switch indication and/or cross-link power save state switch indication.

In some implementations, a management information base (MIB) variable, for example, dotl1MLPMlmplemented, may be assigned to this feature. It may be set to true when the MLPM capability is supported. Otherwise, it may be set to false.

In some embodiments, the definition and encoding of the MLPM Support subfield may be implemented as shown by Table 1 below.

TABLE 1

| Subfield | Definition | Encoding |
|---|---|---|
| MLPM | An AP MLD indicates | For an AP MLD: |
| Support | support for receiving | Set to 1 if each AP of the |
| | a frame containing an | AP MLD supports receiving a |
| | indication of cross- | frame containing an indication |
| | link power management | of cross-link power management |
| | mode indication and | mode indication and cross-link |
| | cross-link power save | power save state indication; and |
| | state indication | Set to 0 otherwise. |
| | | For a non-AP MLD: Reserved. |

In some implementations, the support for cross-link PM mode indication and cross-link power save state indication may be mandatory for the AP MLD. Thus, the MLPM capability indication may not be necessary.

In some embodiments, the AP MLD may indicate inter-AP processing delay, for example, the MLPM Delay in FIG. 7, that is the amount of time required to process and successfully apply the cross-link PM mode indication and cross-link power save state indication received at the first AP affiliated with the AP MLD. The inter-AP processing delay may be also utilized by a STA associated with a second AP affiliated with the same AP MLD. In some implementations, the MLPM Delay may be a predetermined amount of time so that any AP MLD with the MLPM Support capability has to comply with it. In another implementations, the value for the MLPM Delay may be AP-specific and may be indicated in the Common Information field of the Basic Multi-link element transmitted by an AP MLD. For example, the value for the MLPM Delay may be included in the MLPM Delay subfield in either the EML Capabilities subfield or the MLD Capabilities and Operation subfield of the Common Info field of the Basic Multi-link element. FIG. 7 shows an example that MLPM Delay subfield is included in the MLD Capabilities and Operations field in a Basic Multi-link element transmitted by an AP affiliated with an AP MLD. In some embodiments, the MLPM Delay subfield may be implemented as shown by Table 2 below. In some embodiments, the MLPM Delay subfield may be reserved if the Basic multi-link element is transmitted by a non-AP MLD or by an AP MLD with the MLPM Support subfield set to 0. In some embodiments, the value for the MLPM Delay may be link-specific and can be indicated in the Link Info field of the Basic Multi-link element.

TABLE 2

| MLPM Delay subfield value | MLPM Delay | |
|---|---|---|
| 0 | 0 | μs |
| 1 | 8 | μs |
| 2 | 16 | μs |
| 3 | 32 | μs |

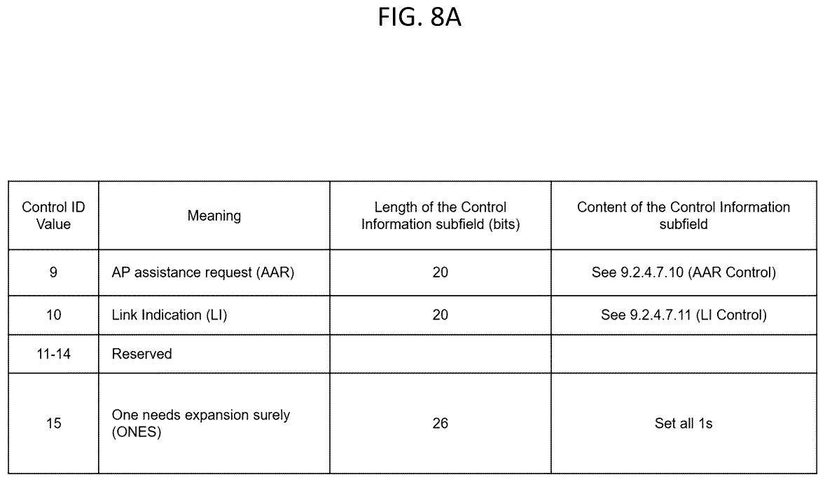

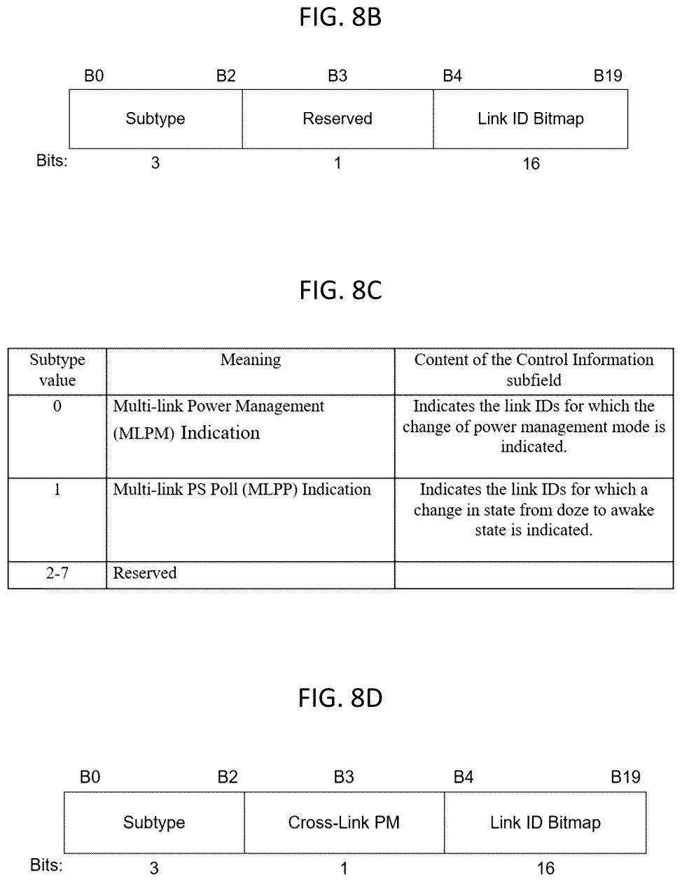

In some embodiments, the cross-link PM mode indication and the cross-link power save state indication for a first STA affiliated with a non-AP MLD may be carried in a new A(aggregated)-control field that is transmitted by a second STA affiliated with the same non-AP MLD. The new A-control field may be a link indication (LI) Control subfield. The LI Control subfield may be transmitted by the second STA in the HE-variant HT control field within a QoS Data frame or a QoS Null frame. In some embodiments, the LI Control subfield may be a general purpose A-control subfield as shown in FIGS. 8A to 8D.

FIG. 8A shows an example table of control ID subfield values for HE-variant HT control field in accordance with an embodiment. As shown in FIG. 8A, the LI Control subfield may be defined as a new A-control field, along with other new A-control fields such as AP assistance request (AAR) Control subfield.

FIG. 8B shows an example of control information subfield format in the LI Control subfield in accordance with an embodiment. Further, FIG. 8C shows an example of the subtype subfield of the LI Control subfield in accordance with an embodiment. The control information subfield in the LI Control subfield may be used by a STA of the non-AP MLD to inform the AP MLD of a set of link IDs of the STAs affiliated with non-AP MLD which are associated with the power management mode change and/or the power save state switch change.

Referring to FIG. 8B, the control information subfield format in a LI Control subfield may include a Subtype subfield, a Reserved subfield, and a Link ID Bitmap subfield. The bit sizes of those subfields may be 3 bits, 1 bit, and 16 bits, respectively. The Subtype subfield may indicate the purpose of the Link ID bitmap subfield. More specifically, it may indicate if the Link ID Bitmap subfield includes MLPM (Multi-link Power Management) indication or Multi-link PS Poll (MLPP) indication. The Link ID Bitmap subfield may indicate link IDs associated with the MLPM indication or the MLPP indication.

Referring to FIG. 8C, when the Subtype value is set to 0, the Link ID Bitmap subfield may include the MLPM indication, which may indicate the link IDs for which power management mode is indicated. Additionally, when the Subtype value is set to 1, the Link ID Bitmap subfield may include the MLPP indication, which may indicate the link IDs for which a change from doze state to awake state is indicated. Other values may be reserved for potential future purposes.

When transmitted by a STA affiliated with a non-AP MLD to an AP affiliated with an AP MLD, the LI Control subfield with the MLPP subtype may indicate the link IDs of STAs affiliated with the non-AP MLD which are transitioning from doze state to awake state. In some implementations, a value of 1 in bit position i of the Link ID Bitmap subfield may indicate to the AP MLD that the STA affiliated with the non-AP MLD operating on the link with link ID equal to i is transitioning from doze state to awake state. Additionally, a value of 0 in bit position of the Link ID Bitmap subfield may indicate to the AP MLD that the STA affiliated with the non-AP MLD operating on the link with link ID equal to i is not transitioning from doze state to awake state.

In an embodiment, the LI Control subfield with MLPP subtype may not be transmitted by an AP MLD. However, in another embodiment where the power save mode is applicable for the AP MLD, the LI Control subfield with MLPP subtype may be transmitted by an AP MLD.

In an embodiment, the non-AP MLD may ensure that the STA, indicated as 1 in the Link ID Bitmap subfield of the LI Control subfield with MLPP subtype, transitions to the awake state within the MLPM Delay duration from the successful transmission of the LI Control subfield. The non-AP MLD may obtain the MLPM Delay duration from capabilities information in the Basic Multi-link element previously transmitted from the associated AP MLD. In another embodiment, the non-AP MLD may ensure that the STA, indicated as 1 in the Link ID Bitmap subfield of the LI Control subfield with MLPP subtype, transitions to the awake state before transmission of the LI Control subfield.

When an AP affiliated with an AP MLD receives a frame including the LI Control subfield with the MLPP subtype from a non-AP MLD, the AP may share the power save state switch information with other APs operating on the links indicated as ‘1’ in the Link ID bitmap subfield. These other APs may schedule the transmission of buffered BUs or traffic for their respective STAs affiliated with the non-AP MLD operating on their respective links immediately after the duration specified by the MLPM Delay subfield, following the receipt of the LI Control subfield with the MLPP subtype.

When the LI Control subfield with the MLPM subtype is transmitted by a STA affiliated with a non-AP MLD to an AP affiliated with an AP MLD, it may indicate the link IDs of the STAs affiliated with the non-AP MLD which are transitioning from active mode to power save mode or from power save mode to active mode. In some implementations, the Reserved subfield, shown in FIG. 8B, in the LI Control subfield with the MLPM subtype may be implemented as ‘Cross-link PM subfield’ as shown in FIG. 8D. In FIG. 8D, the Cross-link PM subfield has a single bit. When the power management mode on the indicated links transitions from active mode to power save mode, the Cross-link PM subfield may be set to 1. Conversely, when the power management mode on the indicated links transitions from power save mode to active mode, the Cross-link PM subfield may be set to 0.

In some implementations, when the Cross-link PM subfield is set to ‘1’, a value of 1 in bit position i of the Link ID Bitmap of the LI Control subfield may indicate to the AP MLD that the STA affiliated with the non-AP MLD operating on the link with link ID equal to i is transitioning from active mode to power save mode. Similarly, when the Cross-link PM subfield is set to ‘0’, a value of 1 in bit position i of the Link ID Bitmap of the LI Control subfield may indicate to the AP MLD that the STA affiliated with the non-AP MLD operating on the link with link ID equal to i is transitioning from power save mode to active mode. In an embodiment, the bit corresponding to the link where the LI Control subfield with the MLPM subtype is transmitted may be always set to 0.

In some embodiments, a non-AP MLD may ensure that the STA, indicated as transitioning from active mode to power save mode in the LI Control subfield with the MLPM subtype, transitions to doze state immediately after an MLPM Delay duration from transmission of the LI Control subfield. Thus, if the indicated STA receives a downlink frame during the MLPM Delay duration, the STA should complete the frame exchange sequence and indicate its powers management mode state again using the PM bit within the frame exchange sequence.

When an AP affiliated with an AP MLD receives a frame including an LI Control subfield with the MLPM subtype from a non-AP MLD, the AP may share the information with other APs operating on links indicated as 1 in the Link ID bitmap subfield. These other APs may begin buffering traffic or BUs for their respective STAs affiliated with the non-AP MLD operating on their respective links immediately after the duration specified by the MLPM Delay, following the receipt of the LI Control subfield.

In some embodiments, the non-AP MLD may ensure that the STA, indicated as transitioning from power save mode to active mode in the LI Control subfield with the MLPM subtype, transitions to the awake state within the MLPM Delay duration from transmission of the LI Control subfield. In another embodiment, the non-AP MLD may ensure that the STA, indicated as transitioning from power save mode to active mode in the LI Control subfield with the MLPM subtype, transitions to the awake state before transmission of the LI Control subfield.

When an AP affiliated with an AP MLD receives a frame including an LI Control subfield with the MLPM subtype from a non-AP MLD, the AP may share the information with other APs operating on links indicated as 1 in the Link ID bitmap subfield. These other APs may schedule for transmissions of buffered BUs or traffic for their respective STAs affiliated with the non-AP MLD operating on their respective links immediately after the duration specified by the MLPM Delay subfield, following the receipt of the LI Control subfield with the MLPP subtype.

In an embodiment, an LI Control subfield with the MLPM subtype may not be transmitted by an AP MLD. However, in another embodiment where power management mode change is applicable for the AP MLD, the LI Control subfield with the MLPM subtype may also be transmitted by the AP MLD.

In a variant of the embodiment explained with reference to FIG. 8D, the bit B3, corresponding to the Cross-link PM subfield, of the LI Control subfield with the MLPM subtype may be reserved. Instead, the Link ID Bitmap subfield, in conjunction with the PM bit of the frame control field carried in the frame including the LI Control subfield with the MLPM subtype, may be used to determine if the MLPM indication is for transitioning from active mode to power save mode indication or for transitioning from power save mode to active mode indication.

For convenience of description, it is assumed that the ID of the link on which the frame including the LI Control subfield with the MLPM subtype is transmitted is j. Then, the MLPM indication may be interpreted as follows:
If the PM bit in the frame control field is set to 1 and the bit corresponding to link ID j in the Link ID Bitmap subfield of the LI Control subfield is set to 1, the MLPM indication is for transitioning from active mode to power save mode. For instance, a value of 1 in bit position i of the Link ID Bitmap subfield may indicate that the STA affiliated with the non-AP MLD operating on the link with link ID equal to i is transitioning from active mode to power save mode.
If the PM bit in the frame control field is set to 1 and the bit corresponding to link ID j in the Link ID Bitmap subfield of the LI A-control subfield is set to 0, the MLPM indication is for transitioning from power save mode to active mode. For instance, a value of 1 in bit position i of the Link ID Bitmap subfield may indicate that the STA affiliated with the non-AP MLD operating on the link with link ID equal to i (except for i=j) is transitioning from power save mode to active mode.
If the PM bit in the frame control field is set to 0 and the bit corresponding to link ID j in the Link ID Bitmap subfield of the LI A-control subfield is set to 1, the MLPM indication is for transitioning from power save mode to active mode. For instance, a value of 1 in bit position i of the Link ID Bitmap subfield may indicate that the STA affiliated with the non-AP MLD operating on the link with link ID equal to i is transitioning from power save mode to active mode. & If the PM bit in the frame control field is set to 0 and the bit corresponding to link ID j in the Link ID Bitmap subfield of the LI A-control subfield is set to 0, the MLPM indication is for transitioning from active mode to power save mode. For instance, a value of 1 in bit position i of the Link ID Bitmap subfield may indicate that the STA affiliated with the non-AP MLD operating on the link with link ID equal to i (except for i=j) is transitioning from active mode to power save mode.

In the above example, the XOR between the PM bit and the bit corresponding to link ID j in the Link ID Bitmap subfield of the LI Control subfield with the MLPM subtype may be used to determine if the MLPM indication is for transitioning from active mode to power save mode indication or vice versa. In this example, all the links for which corresponding bits in the Link ID Bit map are set to 1 except for the link ID j are determined as indicated links for the power management mode switch. A value of 0 in bit position i of the Link ID Bitmap may indicate to the AP MLD that STA affiliated with the non-AP MLD operating on the link with link ID equal to i is not a STA indicated for the management mode switch. In this example, the indication of link ID j may be determined from the PM bit.

In some embodiments, the bit corresponding to link ID i in the Link ID Bitmap subfield of the LI Control subfield with the MLPM subtype may function in a similar manner to the PM bit for link ID i. In some implementations, a value of 1 in bit position i of the Link ID Bitmap subfield may indicate that the STA affiliated with the non-AP MLD operating on the link with link ID equal to i is entering the power save mode. A value of 0 in bit position i of the Link ID Bitmap subfield may indicate that the STA affiliated with the non-AP MLD operating on the link with link ID equal to i is entering the active mode. In these embodiments, the indication may not necessarily imply that the power management mode is changing on the corresponding link.

As will be explained in further detail below, the cross-link power management indication and/or the cross-link power save state indication may be transmitted within a new protected EHT (extremely high throughput) Action frame. The new Protected EHT Action frame may be a single action frame that is applicable for both indications, and it may be referred to as a ‘Multi-link Power Management (MLPM) Notification frame.’

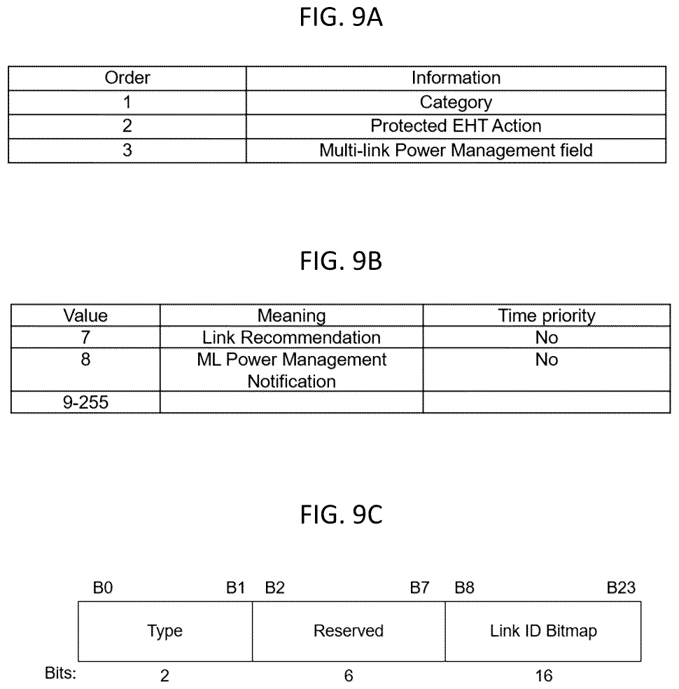

FIG. 9A shows an example of a MLPM Notification frame format in accordance with an embodiment. FIG. 9B shows an example of Protected EHT Action field values in accordance with an embodiment. FIG. 9C shows an example of a MLPM Notification field format in accordance with an embodiment. As discussed, in this example the MLPM Notification frame is a newly defined Protected EHT Action frame.

Referring to FIG. 9A, the MLPM Notification frame may include a Category field, a Protected EHT Action field, and a Multi-link Power Management (MLPM) field. The Category field may include category values about the action frame. The Protected EHT Action field may differentiate the Protected EHT Action frame from others. FIG. 9B is an example table of the Protected EHT Action field values including the MLPM Notification frame in accordance with an embodiment. The MLPM field is explained in further detail below with reference to FIG. 9C.

Referring to FIG. 9C, the MLPM Notification field may include a Type subfield, a Reserved subfield, and a Link ID Bitmap subfield. In this example, the bit sizes of these subfield may be 2 bits, 6 bits, and 16 bits, respectively. The Type subfield may indicate a type of power management change. Table 3 below shows an example of definition and encoding of the MLPM Support subfield.

TABLE 3

| Type | Meaning |
|---|---|
| 0 | Indication of change of power management mode from active |
| | mode to power save mode |
| 1 | Indication of change of power management mode from power |
| | save mode to active mode |
| 2 | Indication of change of power save state from doze state |
| | to awake state |
| 3 | Reserved |

The above encoding may indicate whether the purpose of the MLPM Notification frame is for indication of multi-link power management mode change or for indication of multi-link power save state change. In some implementations, the Type subfield may have only a single bit to indicate if it is for power management mode indication (e.g., set to 1) or power save state indication (e.g., set to 0).

The Link ID Bitmap subfield may indicate link IDs for power management mode indication or power save state indication. In some embodiments, the encoding of the Link ID Bitmap subfield may be implemented as below. For example, a value of 1 in bit position i of the Link ID Bitmap subfield may indicate that the STA affiliated with the non-AP MLD operating on the link with link ID equal to i is associated with power management mode change or power save state change. Conversely, a value of 0 in bit position i of the Link ID Bitmap subfield may indicate that the STA affiliated with the non-AP MLD operating on the link with link ID equal to i is not associated with power management mode change or power save state change. In some embodiments, the Link ID bitmap subfield may be encoded in a similar manner as discussed with reference to FIGS. 8B and 8D. In an embodiment, the MLPM Notification frame may not be transmitted by an AP MLD.

In some embodiments, when the Type subfield is set to 0 or 1, the indication for the link on which the transmitting STA is operating may not contradict the indication in the PM bit of the frame control field carrying the MLPM Notification frame.

In some embodiments, the non-AP MLD may ensure that the STA, indicated as 1 in the Link ID Bitmap subfield with the Type subfield set to 1 or 2, transitions to awake state within the MLPM Delay duration from transmission of the MLPM Notification frame. In some embodiments, the non-AP MLD may ensure that the STA, indicated as 1 in the Link ID Bitmap subfield with the Type subfield set to 1 or 2, transitions to awake state before transmission of the MLPM Notification frame.

In some embodiments, the non-AP MLD may ensure that the STA, indicated as 1 in the Link ID Bitmap subfield with the Type subfield set to 0, transitions to doze state of power save mode immediately after the MLPM Delay duration following the transmission of the MLPM Notification frame.

When an AP affiliated with an AP MLD receives an MLPM Notification frame from a non-AP MLD, the AP may share the information with other APs operating on the links indicated as 1 in the Link ID Bitmap subfield of the MLPM field. If the Type subfield is set to 0, the other APs may begin buffering traffic for the STAs affiliated with the non-AP MLD operating on the links after a specific period of time, for example, the MLPM Delay duration, following the receipt of the MLPM Notification frame. If the Type subfield is set to 1, the other APs may stop buffering traffic and may schedule for transmission any buffered traffic for the STAs affiliated with the non-AP MLD operating on those links after a specific period of time, for example, the MLPM Delay duration, following the receipt of the MLPM Notification frame. If the Type subfield is set to 2, the other APs may schedule for transmission any buffered traffic for the STAs affiliated with the non-AP MLD operating on the links, after a specific period of time, for example, the MLPM Delay duration, following the receipt of the MLPM Notification frame.

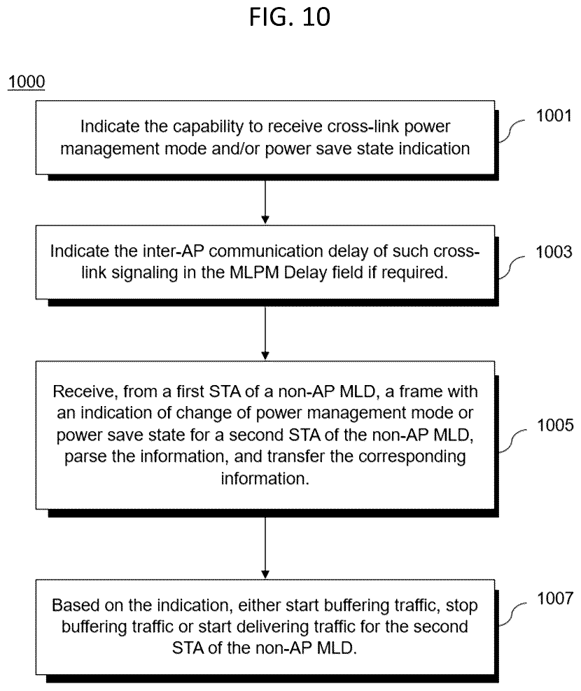

FIG. 10 shows a flow chart illustrating an example process 1000 for an AP MLD in accordance with an embodiment. Although one or more operations are described or shown in particular sequential order, in other embodiments the operations may be rearranged in a different order, which may include performance of multiple operations in at least partially overlapping time periods.

The process 1000 may begin in operation 1001. In operation 1001, the AP MLD may indicate, to one or more associated non-AP MLDs, the capability to receive cross-link PM mode switch indication and/or power save sate switch indication.

In operation 1003, the AP MLD may indicate, to one or more associated non-AP MLDs, the inter-AP communication delay of the cross-link signaling (i.e., cross-link PM mode switch indication and/or power save sate switch indication), which may be the amount of time that the AP MLD needs to process and successfully apply the cross-link signaling.

In operation 1005, when a first AP affiliated with the AP MLD receives, from a first STA affiliated with a non-AP MLD, a frame that indicates power management mode switch or power save state switch for a second STA affiliated with the non-AP MLD, the AP MLD may parse the information and transfer the parsed information to a second AP affiliated with the AP MLD. The second AP affiliated with the AP MLD is associated with the second STA affiliated with the non-AP MLD. Then, the process 1000 proceeds to operation 1007.

In operation 1007, the AP MLD may begin or stop buffering the traffic, or start delivering traffic to the second STA affiliated with the non-AP MLD based on the indication about the power management mode switch or the power save state switch.

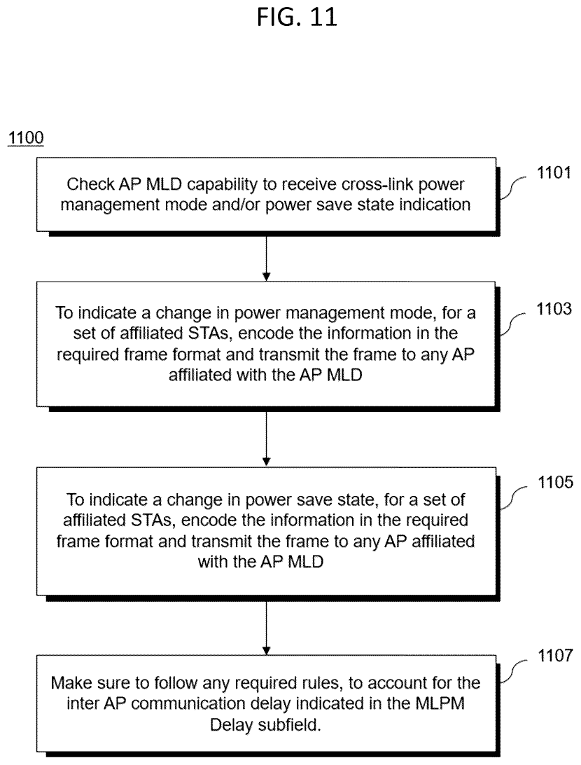

FIG. 11 shows a flow chart illustrating an example process 1100 for a non-AP MLD in accordance with an embodiment. Although one or more operations are described or shown in particular sequential order, in other embodiments the operations may be rearranged in a different order, which may include performance of multiple operations in at least partially overlapping time periods.

The process 1100 may begin in operation 1101. In operation 1101, the non-AP MLD may receive and check the capability information of the AP MLD to receive cross-link PM mode switch indication and/or power save state switch indication.

In operation 1103, when there is power management mode switch for a set of STAs affiliated with the non-AP MLD, the non-AP MLD may encode information to indicate the change and transmit a frame including power management mode switch indication to an AP affiliated with the AP MLD. The frame including the power management mode switch indication may be transmitted to any AP affiliated with the associated AP MLD.

In operation 1105, when there is power save state switch for a set of STAs affiliated with the non-AP MLD, the non-AP MLD may encode information to indicate the change and transmit a frame including power save state switch indication to an AP affiliated with the AP MLD. The frame including the power save state switch indication may be transmitted to any AP affiliated with the associated AP MLD.

In operation 1107, the non-AP MLD may ensure compliance with any required rules, taking into account for the inter-AP communication delay indicated in the MLPM Delay subfield. For instance, the non-AP MLD may ensure that the STA, associated with power management mode switch or power save state switch, changes its power management mode or power save state within a specific period of time (e.g., MLPM Delay duration) from transmission of the indication of power management mode switch or power save state switch. In some embodiments, the non-AP MLD may ensure that the STA, associated with power management mode switch or power save state switch, changes its power management mode or power save state before transmission of the indication of power management mode switch or power save state switch.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) associated with an AP MLD in a wireless network, the non-AP MLD comprising:
at least two stations (STAs), each STA being affiliated with the non-AP MLD; and
a processor coupled to the at least two STAs, the processor configured to:
determine power management mode change or power save state change for one or more STAs affiliated with the non-AP MLD; and
transmit, to a first AP affiliated with the AP MLD on a first link established between a first STA affiliated with the non-AP MLD and the first AP, a frame including a field that indicates the power management mode change or the power save state change for the one or more STAs affiliated with the non-AP MLD.

2. The non-AP MLD of claim 1, wherein the field includes a first subfield that indicates if the field includes power management mode change indication or power save state change indication.

3. The non-AP MLD of claim 1, wherein the field includes a second subfield that indicates one or more links of the AP MLD that are associated with the power management mode change or the power save state change.

4. The non-AP MLD of claim 1, wherein the power management mode change is a change from active mode to power save mode or a change from power save mode to active mode, and the power save state change is a change from doze state to awake state or a change from awake state to doze state.

5. The non-AP MLD of claim 2, wherein the frame includes a third subfield that indicates if the power management mode transitions from active mode to power save mode or from power save mode to active mode.

6. The non-AP MLD of claim 5, wherein the power management mode change is determined based on the first subfield and the third subfield.

7. The non-AP MLD of claim 1, wherein the processor is further configured to participate in frame exchange with at least one AP affiliated with the AP MLD on each respective link between the non-AP MLD and the AP MLD, in a case that the field indicates that the one or more STAs transition to active mode or awake state, and wherein the at least one AP is associated with at least one of the one or more STAs.

8. The non-AP MLD of claim 1, wherein the processor is further configured to receive capability information from the AP MLD that indicates whether the AP MLD supports receiving power management mode change indication or power save state change indication for one or more STAs affiliated with the non-AP MLD.

9. The non-AP MLD of claim 1, wherein the processor is further configured to receive processing delay information that indicates an amount of time to process power management mode change indication or power save state change indication.

10. The non-AP MLD of claim 9, wherein the processor is configured to change the power management mode or the power save state for the one or more STAs at a time determined based on the amount of time indicated by the processing delay information.

11. An access point (AP) multi-link device (MLD) associated with a non-AP MLD in a wireless network, the AP MLD comprising:
at least two APs, each AP being affiliated with the AP MLD; and
a processor coupled to the at least two APs, the processor configured to:
receive, from a first STA affiliated with the non-AP MLD on a first link established between the first STA and a first AP affiliated with the AP MLD, a frame including a field that indicates power management mode change or power save state change for one or more STAs affiliated with the non-AP MLD;
in response to determining that the one or more STAs transition to active mode or awake state based on the field included in the frame, initiate frame exchange with at least one of the one or more STAs on each respective link between the AP MLD and the non-AP MLD; and
in response to determining that the one or more STAs transition to doze state based on the field included in the frame, initiate buffering of bufferable units to at least one of the one or more STAs.

12. The AP MLD of claim 11, wherein the field includes a first subfield that indicates if the field includes power management mode change indication or power save state change indication.

13. The AP MLD of claim 11, wherein the field includes a second subfield that indicates one or more links of the AP MLD that are associated with the power management mode change or the power save state change.

14. The AP MLD of claim 11, wherein the power management mode change is a change from active mode to power save mode or a change from power save mode to active mode and the power save state change is a change from doze state to awake state or a change from awake state to doze state.

15. The AP MLD of claim 12, wherein the frame includes a third subfield that indicates if the power management mode transitions from active mode to power save mode or from power save mode to active mode.

16. The AP MLD of claim 15, wherein the processor is configured to determine the power management mode change based on the first subfield and the third subfield.

17. The AP MLD of claim 11, wherein the processor is further configured to transmit capability information to the non-AP MLD that indicates whether the AP MLD supports receiving power management mode change indication or power save state change indication for one or more STAs affiliated with the non-AP MLD.

18. The AP MLD of claim 11, wherein the processor is further configured to transmit processing delay information that indicates an amount of time to process power management mode change indication or power save state change indication.

19. The AP MLD of claim 18, wherein the processor is configured to initiate the frame exchange with the at least one of the one or more STAs or to initiate buffering of the bufferable units to at least one of the one or more STAs at a time determined based on the processing delay information.
